(19) United States
(12) Patent Application Publication
(10) Pub. No.: US 2017/0268823 A1
(43) Pub. Date: Sep. 21, 2017

(54) MEASUREMENT OF ELECTRODE LENGTH IN A MELTING FURNACE

(71) Applicant: CORNING INCORPORATED, CORNING, NY (US)

(72) Inventors: David Gustave Ehrenberg, Coring, NY (US); Dennis Eugene Hay, Folly Beach, SC (US); Ming-Jun Li, Horseheads, NY (US); William Brashear Mattingly, Painted Post, NY (US); Sergey Y Potapenko, Painted Post, NY (US)

(21) Appl. No.: 15/528,948

(22) PCT Filed: Nov. 19, 2015
(86) PCT No.: PCT/US2015/061443

§ 371 Date: May 23, 2017

Related U.S. Application Data
(60) Provisional application No. 62/084,154, filed on Nov. 25, 2014.

(51) Int. Cl. F27B 3/28; G01B 11/02; G01M 11/00; G01N 27/02; G01N 27/22; H05B 7/18; G01S 13/08; G01N 29/04; G01B 7/02; G01N 27/07

(52) U.S. Cl. CPC F27B 3/28; G01B 7/02; G01B 11/02; G01M 11/30; G01N 27/07; G01N 27/226; H05B 7/18; G01S 13/08; G01N 29/04; G01N 27/02

(57) ABSTRACT

The disclosure relates to apparatuses melting batch materials, the apparatuses comprising a vessel; an electrode assembly comprising an electrode and at least one detection component coupled to the electrode; and at least one device configured to measure an electrical or optical property of the electrode assembly. Also disclosed herein are electrode assemblies for the optical or electrical detection of electrode length, and apparatuses comprising such electrode assemblies.

This application claims the benefit of priority to U.S. Application No. 62/084,154 filed Nov. 25, 2014 the content of which is incorporated herein by reference in its entirety.

### FIELD OF THE DISCLOSURE

The present disclosure relates generally to apparatuses for melting batch materials, and more particularly to apparatuses for melting glass batch materials and the measurement of electrode length in such apparatuses.

### BACKGROUND

Melting furnaces can be used to melt a wide variety of batch materials, such as glass and metal batch materials, to name a few. Batch materials can be placed in a vessel having two or more electrodes and melted by applying voltage to the electrodes. The life cycle of a melting furnace can depend, e.g., on electrode wear. For instance, during the melting process, the electrode can be gradually worn down due to contact with the molten batch materials. At some point, the electrode may become too short and may compromise the safe operation of the furnace. For instance, if the electrode wears down past a predetermined point during operation, the batch materials may come into contact with furnace components that may contaminate the batch. In the case of a glass melt, for example, such contact may introduce unwanted contaminants and/or color into the glass melt or final glass product. Moreover, any holes drilled into the electrode and/or furnace can also provide a pathway for leakage of the batch materials, which could compromise the operational safety of the furnace.

The accurate prediction of the end-of-life point for a melting furnace can yield significant cost savings while also maintaining operational safety. In melting furnaces where the electrodes are not replaceable and/or cannot be extended, if one electrode wears to the minimum safe length, then the melting furnace is shutdown. However, during a melting operation, it may not be possible to directly observe or measure the electrode length within the vessel. Applicant has previously calculated electrode length using a mass balance approach. For instance, in the case of an electrode comprising tin oxide, a mass balance of tin oxide in and out of the melt system can be used to estimate remaining electrode length. However, this approach may provide only an average wear value for all electrodes and may not provide information regarding the wear of individual electrode blocks. Additionally, such calculations may have a large margin of error, such as ±30% or more. During operation, several variables can affect the electrode wear rate, such as batch material composition and/or operating temperature, which may complicate the prediction of electrode wear or make a correct prediction impossible.

In the absence of specific values for individual electrode wear, melting furnaces may be shut down early to ensure that the molten batch materials are safely contained. In some instances, it has been discovered that the melting furnaces could have been run safely for several months past the point at which they were shut down. Additional operating time for a melting furnace, e.g., several days or as much as several months, can produce significant capital and operational cost savings.

Accordingly, it would be advantageous to provide methods for accurately estimating the length of electrodes in melting furnaces, which can lead to longer operating times and lower operational costs. Moreover, it would be advantageous to provide apparatuses for melting batch materials that can provide accurate individual electrode endpoint feedback to enable safe operation until the end point is reached.

### SUMMARY

The disclosure relates to apparatuses for melting batch materials, the apparatuses comprising a vessel; at least one electrode assembly disposed within the vessel comprising an electrode and at least one detection component coupled to the electrode; and at least one device configured to measure at least one electrical or optical property of the electrode assembly. According to various embodiments, the batch materials can be chosen from glass batch materials. In additional embodiments, the detection component can comprise an insulating layer, a conductive core surrounded by an insulating layer, or an optical fiber. According to further embodiments, at least one device can be configured to measure at least one of conductivity, impedance, resistance, capacitance, voltage, light intensity, backscattered light intensity, optical reflectivity, oscillation period, and/or frequency of the electrode assembly.

Also disclosed herein are electrode assemblies comprising an electrode and at least one electrical probe coupled to the electrode, wherein the electrical probe comprises a conductive core and an insulating layer surrounding the conductive core; and at least one device configured to measure the resistance or capacitance of the electrical probe. Further disclosed herein are electrode assemblies comprising an electrode, at least one optical probe coupled to the electrode, and at least one device configured to measure at least one optical property of the at least one optical probe. Also disclosed herein are electrode assemblies comprising an electrode and at least one probe coupled to the electrode, wherein the probe comprises an insulating rod comprising two conductive wires connected to an electrical oscillator circuit, and a device configured to measure the oscillation period or frequency of the oscillator circuit. Still further disclosed herein are apparatuses for melting batch materials, such as glass batch materials, comprising the electrode assemblies disclosed herein.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be best understood when read in conjunction with the following drawings, where like structures are indicated with like reference numerals where possible and in which:

FIG. 1 is a schematic illustrating a cross-sectional view of an exemplary melting furnace;

FIGS. 2A-B depict cross-sectional views of an exemplary electrode assembly according to embodiments of the disclosure;

FIGS. 3A-B depict cross-sectional views of an exemplary electrode assembly according to embodiments of the disclosure;

FIG. 4 is a schematic illustrating an exemplary electrode assembly according to embodiments of the disclosure;

FIG. 5 is a schematic illustrating an exemplary probe according to embodiments of the disclosure;

FIG. 6 is a schematic illustrating an exemplary electrode assembly according to embodiments of the disclosure;

FIG. 7A-B depict cross-sectional views of an exemplary electrode assembly according to embodiments of the disclosure;

FIG. 8 is a cross-sectional view of an exemplary electrode assembly according to embodiments of the disclosure;

FIG. 9 is a graphical depiction of scattered light intensity as a function of optical fiber length;

FIG. 10 is a cross-sectional view of an exemplary electrode assembly according to embodiments of the disclosure; and

FIG. 11 is a cross-sectional view of an exemplary electrode assembly according to embodiments of the disclosure.

### DETAILED DESCRIPTION

Apparatuses

Disclosed herein are apparatuses for melting batch materials, the apparatuses comprising a vessel; at least one electrode assembly disposed within the vessel comprising an electrode and at least one detection component coupled to the electrode; and at least one device configured to measure at least one electrical or optical property of the electrode assembly.

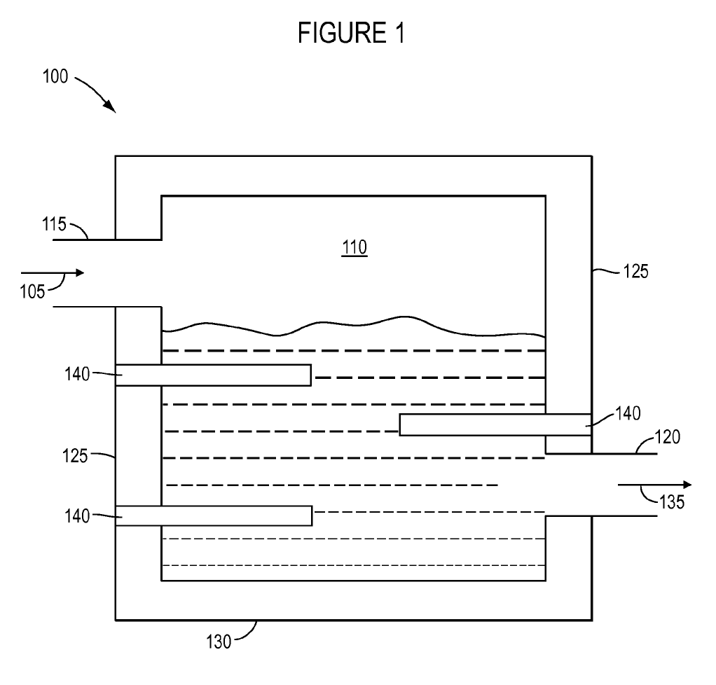

Embodiments of the disclosure will be discussed with reference to FIG. 1, which depicts an exemplary furnace 100 for melting batch materials 105. The melting furnace 100 can include a vessel 110, which can comprise, in some embodiments, an inlet 115 and an outlet 120. Batch materials 105 can be introduced into the vessel 110 by way of the inlet 115. The batch materials can then be heated in the vessel by contact with the side walls 125 and/or bottom 130 of the vessel 110, which can be heated, and/or by contact with at least one electrode 140. The melted batch materials 135 can flow out of the vessel 110 by way of the outlet 120 for further processing.

The term “batch materials” and variations thereof are used herein to denote a mixture of precursor components which, upon melting, react and/or combine to form the final desired product. The batch materials can, for example, comprise glass precursor materials, or metal alloy precursor materials, to name a few. The batch materials may be prepared and/or mixed by any known method for combining precursor materials. For example, in certain non-limiting embodiments, the batch materials can comprise a dry or substantially dry mixture of precursor particles, e.g., without any solvent or liquid. In other embodiments, the batch materials may be in the form of a slurry, for example, a mixture of precursor particles in the presence of a liquid or solvent.

According to various embodiments, the batch materials may comprise glass precursor materials, such as silica, alumina, and various additional oxides, such as boron, magnesium, calcium, sodium, strontium, tin, or titanium oxides. For instance, the glass batch materials may be a mixture of silica and/or alumina with one or more additional oxides. In various embodiments, the glass batch materials comprise from about 45 to about 95 wt % collectively of alumina and/or silica and from about 5 to about 55 wt % collectively of at least one oxide of boron, magnesium, calcium, sodium, strontium, tin, and/or titanium.

The batch materials can be melted according to any method known in the relevant art, e.g., conventional glass and/or metal melting techniques. For example, the batch materials can be added to a melting vessel and heated to a temperature ranging from about 1100° C. to about 1700° C., such as from about 1200° C. to about 1650° C., from about 1250° C. to about 1600° C., from about 1300° C. to about 1550° C., from about 1350° C. to about 1500° C., or from about 1400° C. to about 1450° C., including all ranges and subranges therebetween. The batch materials may, in certain embodiments, have a residence time in the melting vessel ranging from several minutes to several hours to several days, or more, depending on various variables, such as the operating temperature and the batch size. For example, the residence time may range from about 30 minutes to about 3 days, from about 1 hour to about 2 days, from about 2 hours to about 1 day, from about 3 hours to about 12 hours, from about 4 hours to about 10 hours, or from about 6 hours to about 8 hours, including all ranges and subranges therebetween.

In the case of glass processing, the molten glass batch materials can subsequently undergo various additional processing steps, including fining to remove bubbles, and stirring to homogenize the glass melt, to name a few. The molten glass can then be processed, e.g., to produce a glass ribbon, using any known method, such as fusion draw, slot draw, and float techniques. Subsequently, in non-limiting embodiments, the glass ribbon can be formed into glass sheets, cut, polished, and/or otherwise processed.

The vessel 110 can comprise any heat-resistant material suitable for use in a desired melting process, for example, refractory materials such as zircon, zirconia, alumina, magnesium oxide, silicon carbide, silicon nitride, and silicon oxynitride, precious metals such as platinum and platinum alloys, and combinations thereof. According to various embodiments, the vessel 110 can comprise an outer wall or layer (not shown) with an interior lining of heat-resistant material such as a refractory material or precious metal. The vessel 110 can have any suitable shape or size for the desired application and can, in certain embodiments, have a circular, oval, square, or polygonal cross-section. The dimensions of the vessel, including the length, height, width, and depth, to name a few, can vary depending on the desired application. It is within the ability of one skilled in the art to select these dimensions as appropriate for a particular manufacturing process or system.

While FIG. 1 illustrates the electrodes 140 attached to the side walls 125, it is to be understood that the electrodes can be configured within the vessel 110 in any orientation and can be attached to any wall of the vessel 110, such as the roof or bottom of the vessel. Moreover, while FIG. 1 illustrates three electrodes 140, it is to be understood that any number of electrodes may be used as desired for a particular application. Further, while FIG. 1 illustrates a vessel 110 comprising an inlet 115 and an outlet 120, which can be suitable for continuous processing, it is to be understood that other vessels can be used, which may or may not include an inlet and/or outlet, and which can be used for batch or semi-batch processing.

The electrodes 140 can have any dimension and/or shape suitable for operation in a melting furnace. For instance, in some embodiments, the electrodes can be shaped as rods or blocks extending from one or more of the furnace walls. The electrodes can have any suitable cross-sectional shape, such as square, circular, or any other regular or irregular shape. Moreover, the initial length of the electrodes can vary depending on the application and/or size of the melting vessel. In some non-limiting embodiments, the electrodes can have an initial length ranging from about 10 cm to about 200 cm, such as from about 20 cm to about 175 cm, from about 30 cm to about 150 cm, from about 40 cm to about 125 cm, from about 50 cm to about 100 cm, or from about 60 cm to about 75 cm, including all ranges and subranges therebetween.

The electrodes 140 can comprise any material suitable for the desired melting application. For example, the electrode material can be selected such that the normal wear or erosion of the electrode during operation can have little or no detrimental impact on the batch composition and/or final product. In various non-limiting embodiments, such as a glass melting operations, the electrode can comprise one or more oxides or other materials that can be present in the final glass composition. For example, the electrode can comprise an oxide already present in the batch materials (e.g., nominally increasing the amount of the oxide in the final product) or an oxide not present in the batch materials (e.g., introducing small or trace amounts of oxide into the final product). By way of non-limiting example, the electrode can comprise, e.g., stannic tin oxide, molybdenum oxide, zirconium oxide, tungsten, molybdenum zirconium oxide, platinum and other noble metals, graphite, silicon carbide, and other suitable materials and alloys thereof.

According to various embodiments of the disclosure, the vessel 110 can comprise one or more electrode assemblies comprising an electrode and at least one detection component coupled to the electrode. As used herein, the terms “detection component,” “detection structure,” “probe,” and variations thereof are intended to denote any component that, alone or in conjunction with the electrode, can generate a measurable signal or participate in generating a signal, e.g., an electrical or optical signal. The detection component itself can generate a signal, or can be positioned within or adjacent the electrode so as to facilitate the generation of a signal by the electrode itself. For instance, in non-limiting embodiments, the detection component can be chosen from electrical probes, e.g., probes generating an electrical signal such as conductivity, impedance, resistance, capacitance, oscillation period or frequency of a circuit, etc.; and optical probes, e.g., probes generating an optical signal such as light intensity, backscattered light intensity, optical reflectivity, etc. In alternative embodiments, the detection component can be chosen from an insulating component which can, e.g., separate the electrode into two or more portions thereby generating an electrical signal (e.g., capacitance) between the two portions that can be detected.

As used herein the term “coupled to” and variations thereof is intended to denote that a detection component (e.g., probe, optical fiber, etc.) is in physical contact with an electrode. The detection component can be located within the electrode, for instance, inside a hole or channel drilled into or otherwise formed in the electrode. In various embodiments, the detection component can be located at least partially within the electrode. For instance, the detection component can comprise two ends and a center portion between the two ends, and one or both of the ends can be external to the electrode while at least a portion of the detection component (e.g., at least one end or at least a part of the center portion of the component) can be located within the electrode. The portion of the detection component external to the electrode can be connected, e.g., to the at least one detection device. The detection component can also be located on a surface of the electrode, e.g., physically attached to a surface of the electrode.

The apparatuses disclosed herein can comprise various detection mechanisms for estimating the length of an electrode. In some embodiments, the apparatuses may comprise an end-point detection system. In such apparatuses, a property (e.g., electrical or optical property) can change abruptly when the molten batch materials reach a specified point in the electrode. For instance, a change in an electrical property, such as resistance and/or voltage, can occur when the batch materials make first physical contact with a detection structure or probe disposed within the electrode. In other embodiments, the apparatuses may comprise a calibrated length measurement system. In such apparatuses, a property (e.g., electrical or optical property) can change gradually as the electrode length changes. A detection structure or probe can be coupled to the electrode, e.g., within the electrode or adjacent the electrode, and can wear at a rate similar or identical to the electrode wear rate. The probe thus acts as a proxy for the length of the electrode. The electrode length can be estimated by measuring a property of the probe, such as impedance, capacitance, time of flight of electromagnetic radiation, electromagnetic spectral response, oscillation period, frequency, or optical transmission, and correlating the property to the length of the probe and, thus, the length of the electrode.

Electrical Detection

Disclosed herein are electrode assemblies comprising an electrode; at least one electrical probe coupled to the electrode, wherein the electrical probe comprises a conductive core and an insulating layer surrounding the conductive core; and at least one device configured to measure the resistance or capacitance of the electrical probe. In additional embodiments, the electrode assembly can comprise a detection component chosen from insulating layers (e.g., without a conductive core). Apparatuses for melting batch materials, such as glass batch materials, comprising such electrode assemblies are also disclosed herein.

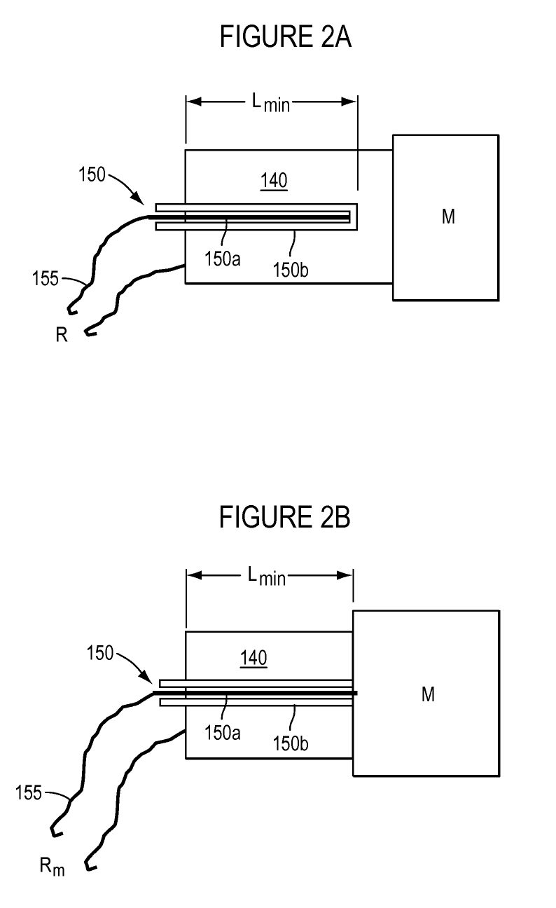

FIGS. 2A-B depict exemplary and non-limiting electrode assemblies according to various embodiments of the disclosure, which can be used to measure electrode length by way of electrical end point detection. In these figures, an electrode 140 is in contact with molten batch materials M. The electrode is equipped with a detection component 150 which, in the illustrated embodiments, can be an electrical probe comprising a conductive core 150a and an insulating layer 150b. The detection component and/or electrode can be connected to a device (not illustrated) via one or more connectors 155, which can relay various electrical and/or optical signals from the detection component and/or electrode. For instance, as illustrated in FIG. 2A, the detection component 150 can be inserted into the electrode 140 to a point corresponding to a predetermined minimum electrode length Lₘᵢₙ. The tip of the detection component 150 can align with the predetermined point. Until the molten batch materials M erode the electrode to the predetermined minimum electrode length Lₘᵢₙ, e.g., while the electrode length is longer than the minimum electrode length, the insulating layer 150b at the tip of the detection component 150 can remain intact, e.g., undissolved. Thus, a relatively high resistance R between the conductive core 150a and the electrode 140 can be maintained.

FIG. 2B illustrates the same exemplary electrode assembly, after the molten batch materials M have eroded the electrode 140 to the predetermined point, signaling that the electrode has reached the minimum length Lₘᵢₙ. The tip of the insulating material 150b can dissolve in the molten batch materials M, thereby exposing the conductive core 150a to the conductive melt M. The electrically conductive molten batch materials M should then “connect” the conductive core to the surrounding electrode, which can lower the resistance Rₘ between the conductive core 150a and the electrode 140. The resistance Rₘ can depend on various factors, such as the resistivity of the molten batch materials and/or the probe and electrode dimensions. However, the resistance Rₘ can be relatively low (e.g., about 1 Ohm) as compared to the resistance R when the electrode is longer than the minimum electrode length Lₘᵢₙ, with the tip of the insulating material substantially intact. The change in resistance from R (high) to Rₘ (low) can signal that the electrode is near or at the endpoint at which it can be used safely in operations. A sudden change in resistance can, in some embodiments, trigger the shutdown of the furnace or any other appropriate actions in the furnace operation.

The minimum electrode length Lₘᵢₙ can be any length at which it may be advantageous to halt operations, whether for safety reasons or other operational concerns. In certain embodiments, the detection component can signal that the electrode length is less than about 100 mm in length, such as less than about 75 mm, less than about 60 mm, less than about 50 mm, or less than about 40 mm, including all ranges and subranges therebetween. For example, structures in the electrode and/or the holes drilled to accommodate such structures can extend into the electrode to a depth of about 40 mm from the cold end. In various embodiments, a margin of safety, such as greater than about 10 mm, e.g., from about 10 mm to about 35 mm, can be added to ensure safe operation of the furnace.

The detection component 150 can, in some embodiments, be an electrical probe comprising a conductive core 150a surrounded by an insulating layer 150b. Both the conductive core and the insulating layer should be chosen to withstand the working temperatures of the melting apparatus. The conductive core can comprise any number of conductive materials including, but not limited to, metals, metal alloys, metal oxides, and combinations thereof. These materials may or may not be soluble in the molten batch materials M. In certain embodiments, the core can comprise precious metals and alloys, such as platinum and platinum alloys, e.g., Pt/Rh alloys. The insulating layer can be chosen from any number of non-conductive materials, such as ceramic and glass materials, e.g., glass, alumina, fused silica, and other oxides that may be present in the molten batch materials, to name a few. A non-limiting embodiment of a commercially available insulating material is the high temperature, high silica-content Vycor® glass from Corning Incorporated. According to various embodiments, the insulating layer can be soluble in and/or otherwise destructible by the molten batch materials M.

The conductive core and/or insulating layer materials can be chosen, in certain embodiments, from materials that may not significantly contaminate the batch materials and/or final product. For instance, the conductive core can comprise a material that either does not dissolve or does not substantially dissolve in the batch materials at the operating temperature (e.g., Pt and Pt alloys). Alternatively, the conductive core and/or insulating layer can comprise a material that can dissolve in the batch materials, but does not introduce undesired material or properties (e.g., contaminants and/or coloration) to the batch and/or final product, such as a material the same as or similar to that used to construct the electrode. Thus, in some non-limiting embodiments, the probe can be constructed from materials already present in the batch composition or materials that can be present in the final product (e.g., not originally present in the batch composition) without producing undesirable results.

The dimensions of the detection component 150 can vary depending on the application and, for instance, the size of the electrode to which it is coupled. The detection component can, for example, be chosen from rods, wires, or blocks of electrically conductive material sheathed with at least one layer of a non-conductive material. In certain embodiments, the probe can measure and provide additional information relevant to the melt process, such as temperature, pressure, etc. Accordingly, the probe can, in various embodiments, comprise a conductive thermocouple with a non-conductive sheath.

Non-limiting examples of suitable probe dimensions can include, e.g., a diameter or thickness ranging from about 3 mm to about 15 mm, such as from about 5 mm to about 12 mm, or from about 8 mm to about 10 mm, including all ranges and subranges therebetween. In additional embodiments, the insulating layer can have a thickness ranging from about 0.5 mm to about 10 mm, such as from about 1 mm to about 8 mm, from about 2 mm to about 7 mm, from about 3 mm to about 6 mm, or from about 4 mm to about 5 mm, including all ranges and subranges therebetween.

The probe can be disposed at least partially within the electrode, such as within a hole or channel drilled or otherwise provided in the electrode. The diameter of such a hole or channel can vary as desired, keeping in mind various practical considerations. For example, the diameter should be small enough to avoid reducing the structural integrity of the electrode while also being large enough to accommodate the probe and reduce or avoid manufacturing difficulties. According to various embodiments, the diameter can range from about 5 mm to about 40 mm, such as from about 10 mm, to about 35 mm, from about 15 mm to about 30 mm, or from about 20 mm to about 25 mm, including all ranges and subranges therebetween.

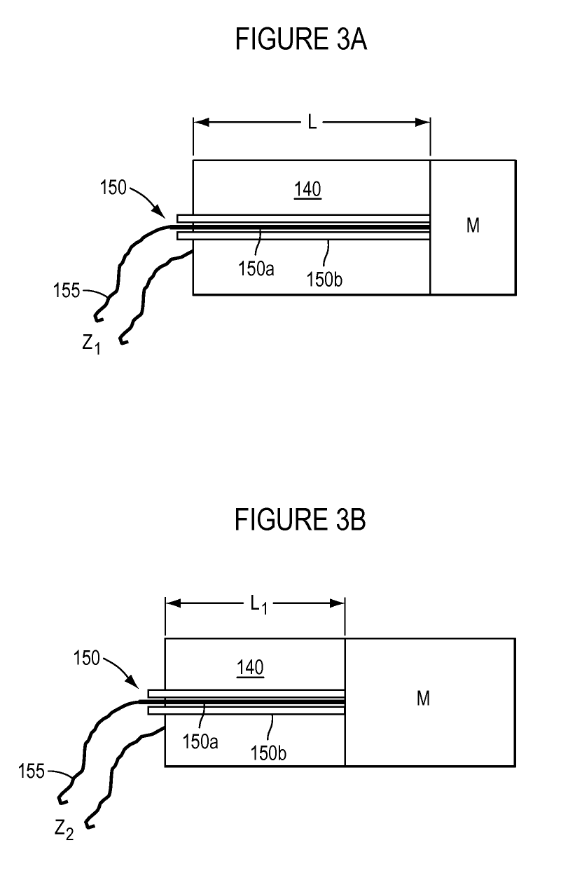

FIGS. 3A-B depict alternative non-limiting embodiments, in which electrode length can be measured by way of an electrical calibrated length measurement system. In these figures, similar to the embodiments of FIGS. 2A-B, an electrode 140 is in contact with molten batch materials M. The electrode is equipped with a detection component 150 which, in the illustrated embodiments, can comprise an electrical probe comprising conductive core 150a and an insulating layer 150b. The detection component and/or electrode can be connected to a device (not illustrated) via one or more connectors 155, which can relay various electrical and/or optical signals from the detection component and/or electrode.

For instance, as illustrated in FIG. 3A, the detection component 150 can have a length L substantially similar to or the same as the electrode length. As depicted in FIG. 3B, during operation the molten batch materials M can erode the electrode (and detection component), thus yielding a detection component with a shorter length L₁. The detection component and electrode have, in various embodiments, substantially similar erosion rates or the same erosion rate under the given operating conditions (e.g., temperature, batch composition, etc.). According to certain embodiments, to assure that the detection component and the electrode respective erosion rates are substantially similar or the same, the detection component and the electrode can be electrically connected with an external connector, e.g., electrical wire, to monitor their respective lengths when the measurements are not taken. During the measurement the probe should be disconnected from the electrode and connected to the measuring device. In additional embodiments, the conductive core 150a can comprise the same material as the electrode. The insulating layer can comprise any suitable material discussed with respect to FIGS. 2A-B.

The resistance R_{c} and capacitance C of the conductive core can be proportional to the length L of the detection component. The resistance of the core can be estimated using formula (1):

$${R}_{c} = \frac{{ρ}_{c} L}{A} , \qquad ( 1 )$$

and the capacitance of the core can be estimated using formula (2):

$$C = \frac{2 {πɛɛ}_{0} L}{ln \frac{d}{d + 2 w}} , \qquad ( 2 )$$

where d is the diameter of the conductive core, w is the insulating gap width, ∈ is the insulation dielectric constant, ∈ₒ is the dielectric vacuum permittivity, ρ_{c} is the core resistivity, L is the electrode length, and A is the cross-sectional area of the core. During length measurement, the detection component should not be electrically connected to the electrode. The measured electrical property Z₁ at the initial length L can be compared to the measured electrical property Z₂, which may indicate that the detection component has reached a shorter length L₁. For example, by monitoring the resistance R_{c} and/or capacitance C of the detection component, e.g., electrical probe, it can be possible to estimate the length L₁ of the detection component (and thus the electrode) at any given point in time.

The resistance of the core may, in some embodiments, be relatively small as compared to the resistance of the molten batch materials. Thus, in various embodiments, it may be advantageous to measure the capacitance of the core. Capacitance measurements can be made using any method known in the art, for instance, standard methods for impedance measurement. Alternatively, the detection component surrounded by the conducting electrode can be effectively conceptualized as a “coaxial cable” terminated by a resistor (molten batch materials). Measuring the length of the “coaxial cable” (and thus the electrode length) can thus be carried out using standard Time Domain Reflection (TDR) methods or by measuring the resonant frequencies.

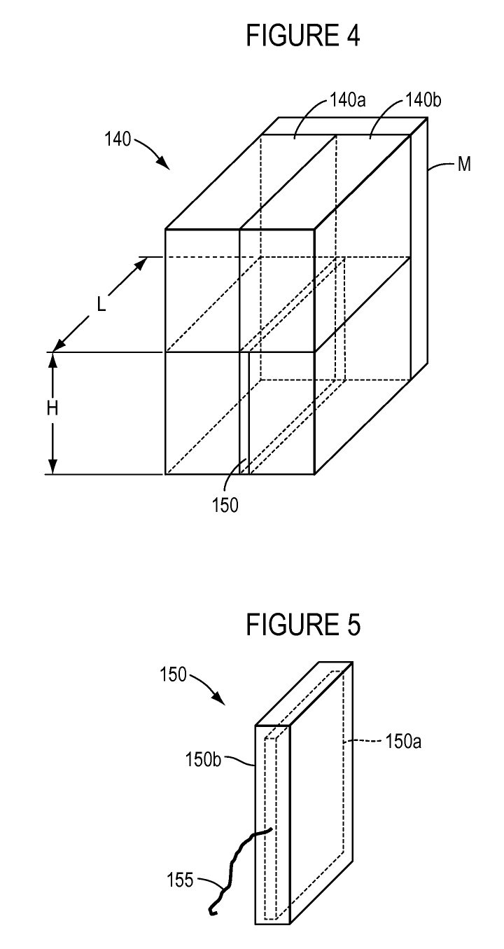

While FIGS. 3A-B depict a one-dimensional detection component, e.g., a probe extending predominantly in one direction, such as a rod, wire, cable, or fuse, it is also possible, in additional embodiments, to employ a two-dimensional detection component, such as a planar probe, or even a three-dimensional detection component, such as a block. FIG. 4 depicts such an exemplary, non-limiting embodiment, in which an electrode assembly comprises a multi-dimensional detection component. For example, the detection component 150 can be placed between two portions or blocks 140a and 140b of an electrode 140, as depicted in FIG. 4, although other configurations are possible and envisioned as falling within the scope of the disclosure. While FIG. 4 depicts a substantially planar detection component placed between two electrode blocks having substantially the same dimensions, e.g., in the middle of the electrode, it is to be understood that the detection component may also be placed off-center, e.g., between two blocks having different dimensions. Moreover, in certain embodiments, the detection component can be placed outside of the electrode, e.g., attached or coupled to one or more of the electrode surfaces, such as the top, sides, or bottom of the electrode.

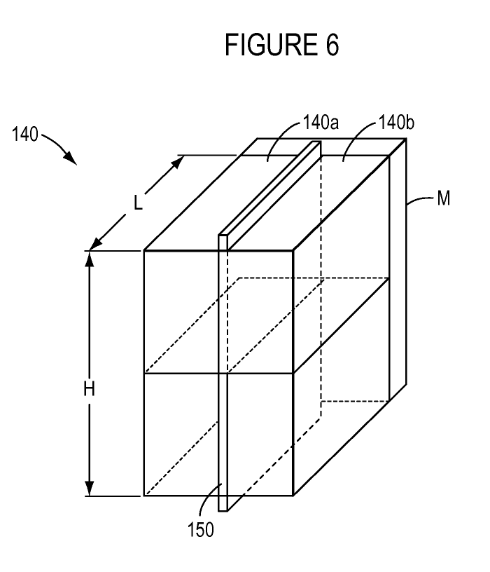

As with the one-dimensional detection component, the resistance and capacitance can be proportional to the surface area of the detection component and thus the length L (and height h) of the detection component (A=h×L). As depicted in FIG. 5, a detection component 150, e.g., electrical probe, can comprise a conductive core 150a surrounded by at least one insulating layer 150b and can be connected to at least one measuring device (not shown) by way of at least one connector 155. FIG. 6 shows yet another embodiment of an electrode assembly according to the disclosure, in which two or more portions of an electrode are separated by a detection component. The detection component can comprise an insulating layer and, in some embodiments, may not comprise a conductive core (as opposed to the probe illustrated in FIG. 5). According to the non-limiting embodiment depicted in FIG. 6, two electrode portions or blocks 140a and 140b can be separated by an insulating layer 150b. The insulating layer should create electrical capacitance between the two electrode blocks, which can be proportional to the surface area and thus the length L (and height H) of the probe (A=H×L). Thus, in this embodiment, the electrode length can be estimated by measuring the capacitance between the two electrode blocks. During measurement, the two electrode blocks should not be electrically connected to one another, e.g., by a main power cable or other means.

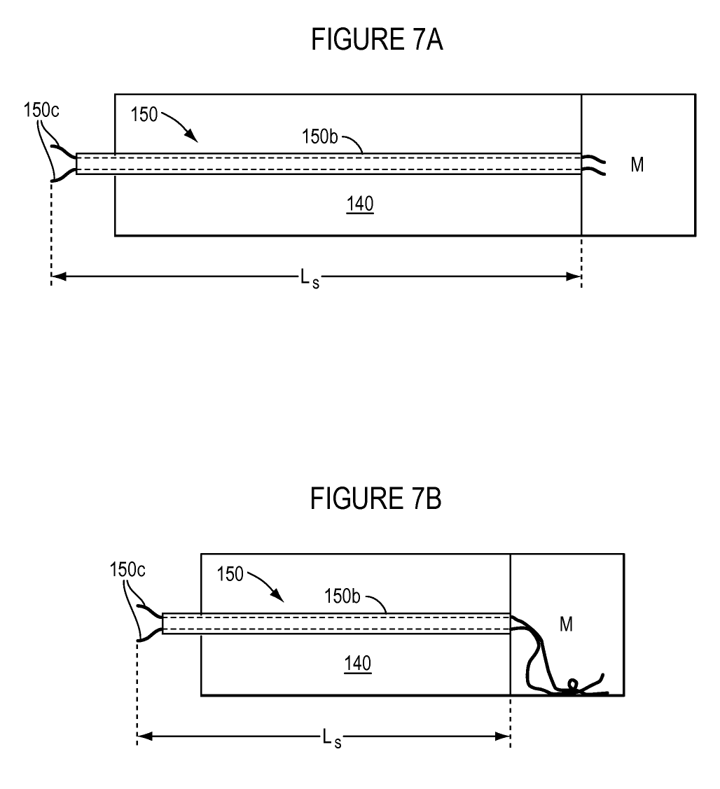

FIGS. 7A-B depict exemplary non-limiting electrode assemblies according to various embodiments of the disclosure, in which electrode length can be measured by way of an electrical circuit (e.g., shortage stub tuned oscillator circuit). In these figures, an electrode 140 is in contact with molten batch materials M. The electrode is equipped with a detection component 150 which, in the illustrated embodiments, can comprise an insulating layer 150b and conductive wires 150c. For example, the detection component can comprise a rod constructed from an insulating material (e.g., alumina or other suitable ceramic or glass materials), with two wires (e.g., copper or other suitable metals and metal alloys) disposed therein. The wires 150c can be connected to an electrical oscillating circuit (not illustrated), which can relay various signals, such as the oscillation period and/or frequency of the circuit.

By way of a non-limiting example, the detection component 150 can be a multi-vibrator comprising two transistors connected as a differential pair. The two conductive wires 150c can be threaded into the insulating material 150b or rod (also referred to herein as a “stub”), which can be embedded in the electrode to create a shorted (e.g., in the molten batch materials M) transmission line. A signal propagated down the length of the stub is reflected off of the mismatched end of the wire. An initial negative going pulse is created when the first transistor is switched on (or conducts) and forms a positive going pulse after reflection from the mismatched end. When coupled into the base of the opposing second transistor, the positive pulse causes it to conduct and switch off the first transistor, and vice versa. The delay between the transistor on-off switching can be measured as an oscillation period.

Again, the insulating material should erode at a rate similar to or the same as the rate of electrode wear. While the wires themselves may not disintegrate or dissolve in the molten batch materials M (as shown in FIG. 7B), the signal reflection should occur at the point at which the wire is no longer insulated by the stub. The length of the stub Lₛ (and thus the electrode) can then be estimated using a direct correlation between the oscillation period and the insulated wire length, or an inverse correlation between the frequency and the insulated wire length. In other words, a shorter oscillation period (or higher oscillation frequency) will signal a shorter electrode length. For example, the oscillation period (τ) can be correlated to the stub length Lₛ using formula (3):

τ=ALₛ+B (3)

Frequency can be expressed as the inverse of the period (f=1/τ) and can be similarly correlated to the stub length Lₛ (and thus the electrode length).

Optical Detection

Disclosed herein are electrode assemblies comprising an electrode, at least one optical probe coupled to the electrode, and at least one device configured to measure at least one optical property of the at least one optical probe. Apparatuses for melting batch materials, such as glass batch materials, comprising such electrode assemblies are also disclosed herein.

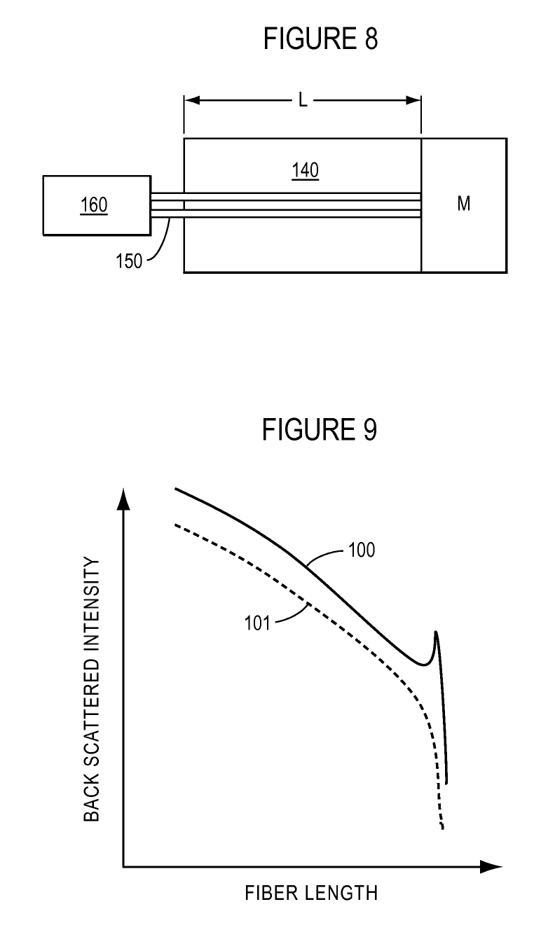

FIG. 8 depicts an exemplary and non-limiting electrode assembly according to various embodiments of the disclosure, which can be used to measure electrode length by way of optical backscattering, e.g., using an optical calibrated length measurement system. An electrode 140 is in contact with molten batch materials M. The electrode can be equipped with a detection component 150 which, in various embodiments, can comprise an optical probe or fiber (as illustrated in FIG. 8). The optical probe can be a single mode or multimode fiber and can comprise any material suitable for use in the desired application. For instance, in some embodiments, the optical fiber can comprise a silica-based glass.

According to certain embodiments, the optical fiber can be hollow or can comprise a core, such as a pure silica core or a silica core doped with at least one dopant, such as index-increasing dopants, e.g., Ge, P, Al, and/or Ti. The core delta can range, for instance, from about 0.2% to about 2%, such as from about 0.3% to about 1.8%, from about 0.5% to about 1.5%, or from about 0.8% to about 1.2%, including all ranges and subranges therebetween. The core diameter can also vary, ranging for example, from about 5 microns to about 500 microns, such as from about 8 microns to about 400 microns, from about 10 microns to about 300 microns, from about 20 microns to about 200 microns, or from about 50 microns to about 100 microns, including all ranges and subranges therebetween. The optical fiber can further comprise a cladding layer which can, in some embodiments, comprise pure silica or silica doped with at least one dopant, e.g., index-decreasing dopants such as F and/or B, or index-increasing dopants, such as Ge, P, Al, and/or Ti. Other dopants can also be added to the fiber, e.g., to change the melting temperature of the fiber, such as CI, K, and/or Na dopants.

The diameter of the optical probe can vary depending on several operating parameters and can range, for example, from about 100 microns to about 10 mm, such as from about 200 microns to about 5 mm, from about 300 microns to about 3 mm, from about 400 microns to about 2 mm, or from about 500 microns to about 1 mm, including all ranges and subranges therebetween. In various embodiments, the optical probe can be inserted into the electrode through a hole or channel. The end point of the probe can correspond to the end of the electrode in contact with the molten batch materials M. The detection component 150, e.g., optical probe, can be connected to a measurement device 160, such as an optical reflectometer (e.g., OBR4600 by LUNA). The length of the optical probe can thus be estimated by measuring the backscattered signal. By assuming that the optical probe is consumed at a rate substantially similar to or the same as the electrode erosion rate, the estimated length of the optical probe can be correlated to the length of the electrode.

According to various embodiments, the optical probe may have a higher softening point than the surrounding electrode, but exposure to the molten batch materials can dissolve the probe in various embodiments. The rate of dissolution of the optical probe can, in certain instances, be higher than the rate of electrode wear. After a period of wear, however, it is believed that the dissolution rate can approximately match the electrode wear as the probe becomes further embedded in the electrode, which can limit exposure. Thus, any offset between the end point of the electrode and the end point of the optical probe can decrease and stabilize over time thereby improving measurement accuracy.

FIG. 9 illustrates backscattered optical intensity as a function of fiber length for two optical fibers. Curve 100 corresponds to an optical fiber with an end that reflects at least a portion of the light. Curve 101 corresponds to an optical fiber with a “soft” fiber end that does not noticeably reflect light. In both instances, the length of the fiber (and thus the length of the electrode) can be determined by the dependencies illustrated in FIG. 9. Of course, more than one probe (or optical fiber) can be included in the electrode to provide additional measurement points, which can increase measurement accuracy and/or reliability.

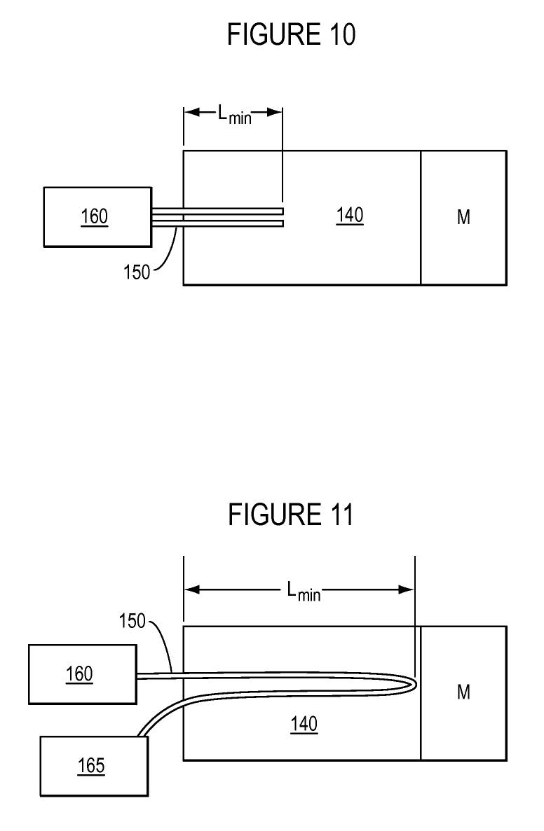

FIG. 10 depicts a further exemplary and non-limiting electrode assembly according to various embodiments of the disclosure, which can be used to measure electrode length by way of optical end point detection, e.g., by detecting optical intensity or radiation. An electrode 140 is in contact with molten batch materials M. The electrode can be equipped with a detection component 150 which, in various embodiments, can comprise an optical probe or fiber (as illustrated in FIG. 10). The probe or fiber can be similar to that described with reference to FIG. 8. The optical probe can be inserted into a hole or channel in the electrode, up to a predetermined minimum length Lₘᵢₙ. The other end of the probe can be connected to a measuring device 160, such as an optical intensity detector (light detector). Until the molten batch materials M erode the electrode to the predetermined minimum length Lₘᵢₙ, e.g., while the electrode length is longer than the minimum electrode length, the molten materials are not in contact with the probe and little or no optical signal may be detected. When the molten materials sufficiently erode the electrode and reach the tip of the optical probe, light from the molten batch materials can enter the probe. The measuring device can then detect the light, e.g., an increase in optical intensity, thus signaling that the minimum electrode length has been reached. As with the configuration illustrated in FIG. 8, it is possible to include more than one optical probe in a given electrode to improve measurement accuracy and/or reliability.

A still further exemplary and non-limiting electrode assembly according to various embodiments of the disclosure is depicted in FIG. 11, which can be used to measure electrode length by way of optical end point detection, e.g., by detecting optical intensity through a fiber loop. An electrode 140 is in contact with molten batch materials M. The electrode can be equipped with a detection component 150 which, in various embodiments, can comprise an optical fiber loop (as illustrated in FIG. 11). The fiber loop can comprise materials and dimensions similar to that described with reference to FIG. 8. The optical fiber loop can comprise two ends and a central portion located between the two ends. The optical fiber loop can be inserted into a hole or channel in the electrode, with one end connected to a measuring device 160, e.g., optical intensity detector, and the other end connected to a light source 165. A portion of the optical fiber loop, for instance, a central portion of the loop, can be disposed within the electrode. A portion of the loop, such as the apex (or turning point) of the loop, can be positioned to substantially correspond to a predetermined minimum length Lₘᵢₙ.

Until the molten batch materials reach the fiber, light from the source 165 can travel continuously through the loop and can be detected by the measuring device 160. When the molten batch materials reach the loop, the fiber will melt or dissolve into the molten batch materials and, in some instances, form two or more discontinuous segments, thereby significantly reducing or eliminating the light intensity registered by the measuring device. The measuring device can detect, e.g., a decrease in optical intensity, thus signaling that the minimum electrode length has been reached. As with the configuration illustrated in FIG. 8, it is possible to include more than one optical fiber to improve measurement accuracy and/or reliability.

In additional embodiments, the configuration illustrated in FIG. 11 can be used with an optical fiber probe without a loop (e.g., one end external to the electrode and one end disposed within the electrode; see, e.g., FIG. 10), if the end of the fiber disposed within the electrode can provide a light reflection significant enough to be measured. Light reflection can also be enhanced by attaching a reflector, such as a mirror or Bragg grating, to the opposite end of the fiber. Once the molten batch materials reach the reflector, the reflector can be destroyed and the reflected signal at the given wavelength may be significantly reduced. Again, the reduced signal can indicate that the electrode is approaching the predetermined minimum length.

Embodiments described herein should not be limited to any specific glass forming process as these embodiments are equally applicable to melters used in fusion forming processes (down draw, slot draw, and the like) as well as to melters used in float forming processes. Furthermore, it is envisioned that embodiments described herein can be used in conjunction with processes and systems which are used to push an exemplary electrode into the melt during the life of the electrode.

It is to be understood that the apparatuses disclose herein are not limited to one type of electrode assembly and can, in various embodiments, comprise combinations of electrode assemblies, such as combinations of assemblies employing electrical or optical detection components and/or combinations of assemblies employing end-point or calibrated length detection components. Moreover, it is to be understood that the various components describe in conjunction with specific embodiments can be used interchangeably to describe similar components in other embodiments without limitation. Further, the detection methods described herein can also be used to measure the length of other components in the melting furnace other than electrodes, e.g., any refractory component that may limit the lifespan of the melter.

The apparatuses disclosed herein may provide one or more advantages over prior art apparatuses. In certain embodiments, the apparatuses disclosed herein can reduce operational down time by enabling electrode length measurement in situ, without the need to drain the batch materials to allow visual assessment of the electrodes. Additionally, the apparatuses disclosed herein can provide more accurate endpoint feedback so as to avoid premature shutdown, thereby providing significant cost savings, while also avoiding glass leakage, thereby ensuring operational safety. Moreover, the electrode assemblies disclosed herein can be retrofit to existing melting furnaces, e.g., by modifying existing electrodes to include one or more detection components, either on the surface of the electrode or within the electrode itself. Measurement of electrical properties to estimate electrode length can be performed using standard methods and equipment and, thus, implementation of these measurements may not substantially increase operational costs. Finally, optical measurement of electrode length may avoid any electrical interference with high power and high voltage circuits. Of course, it is to be understood that the apparatuses disclosed herein may not have one or more of the above advantages, but such apparatuses are intended to fall within the scope of the appended claims.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “an electrode” includes examples having two or more such electrodes unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. An apparatus for melting batch materials, comprising:
a vessel;
at least one electrode assembly disposed within the vessel, the electrode assembly comprising:
an electrode; and
at least one detection component coupled to the electrode; and
at least one device configured to measure an electrical or optical property of the electrode assembly.

2. The apparatus of claim 1, wherein the at least one device is configured to measure at least one of conductivity, impedance, resistance, capacitance, light intensity, backscattered light intensity, or optical reflectivity of the electrode assembly.

3. The apparatus of claim 1, wherein the at least one detection component is an electrical probe comprising a conductive core and at least one insulating layer surrounding the conductive core, and wherein the at least one device is configured to measure an electrical property of the probe.

4. The apparatus of claim 3, wherein the electrical probe is disposed at least partially within the electrode or is located on an exterior surface of the electrode.

5. The apparatus of claim 3, wherein the electrical property is a resistance or capacitance between the conductive core and the electrode, time of flight of electromagnetic wave, or spectral impedance.

6. The apparatus of claim 3, wherein the conductive core comprises at least one conductive material chosen from metals, metal alloys, and metal oxides, and wherein the at least one insulating layer comprises at least one insulating material chosen from ceramic and glass materials.

7. The apparatus of claim 1, wherein the at least one detection component is an insulating layer disposed between two separate portions of the electrode, and wherein the at least one device is configured to measure an electrical property of the electrode.

8. The apparatus of claim 7, wherein the electrical property is a capacitance between the two separate portions of the electrode.

9. The apparatus of claim 1, wherein the at least one detection component is an insulating rod disposed at least partially within the electrode, the insulting rod comprising two conductive wires connected to an electrical oscillator circuit, and wherein the at least one device is configured to measure an electrical property of the detection component.

10. The apparatus of claim 9, wherein the electrical property is an oscillation period or frequency of the electrical oscillator circuit.

11. The apparatus of claim 1, wherein the at least one detection component is an optical fiber disposed at least partially within the electrode, and wherein the at least one device is configured to measure an optical property of the optical fiber.

12. The apparatus of claim 11, wherein the optical property is a light intensity, backscattered light intensity, or optical reflectivity of the optical fiber.

13. The apparatus of claim 11, wherein the optical fiber is chosen from hollow fibers and fibers comprising a silica core optionally doped with at least one index-increasing dopant and at least one cladding layer comprising silica optionally doped with at least one index-increasing or index-decreasing dopant.

14. The apparatus of claim 1, wherein the at least one detection component is at least partially soluble in the batch materials at an operating temperature of the apparatus.

15. The apparatus of claim 1, wherein the at least one detection component has a multi-dimensional geometry.

16. An electrode assembly comprising:
an electrode;
at least one electrical probe coupled to the electrode, wherein the electrical probe comprises a conductive core and at least one insulating layer surrounding the conductive core; and
at least one device configured to measure the resistance or capacitance of the electrical probe.

17. The electrode assembly of claim 16, wherein the electrical probe is disposed at least partially within the electrode or is located on an exterior surface of the electrode.

18. The electrode assembly of claim 16, wherein the conductive core comprises at least one conductive material chosen from metals, metal alloys, and metal oxides, and wherein the at least one insulating layer comprises at least one insulating material chosen from ceramic and glass materials.

19. An electrode assembly comprising:
an electrode;
at least one optical probe coupled to the electrode; and
at least one device configured to measure at least one optical property of the optical probe.

20. The electrode assembly of claim 19, wherein the optical probe is disposed at least partially within the electrode.

21. The electrode assembly of claim 20, wherein the optical probe comprises two ends and a center portion disposed between the two ends, and wherein the center portion is disposed inside the electrode and the two ends are disposed outside the electrode.

22. The electrode assembly of claim 19, wherein the optical probe is chosen from hollow fibers and fibers comprising a silica core optionally doped with at least one index-increasing dopant and at least one cladding layer comprising silica optionally doped with at least one index-increasing or index-decreasing dopant

23. An electrode assembly comprising:
an electrode;
at least one probe coupled to the electrode, wherein the probe comprises an insulating rod and two conductive wires connected to an electrical oscillator circuit; and
at least one device configured to measure the oscillation period or frequency of the electrical oscillator circuit.

24. The electrode assembly of claim 23, wherein the probe is disposed at least partially within the electrode.

25. The electrode assembly of claim 23, wherein the conductive wires comprise at least one conductive material chosen from metals, metal alloys, and metal oxides, and wherein the at least one insulating rod comprises at least one insulating material chosen from ceramic and glass materials.

26. An apparatus for melting glass batch materials comprising at least one electrode assembly as described in any one of claims 16 to 25.

27. A method for measuring electrode length in a melting furnace, wherein the melting furnace comprises an electrode assembly comprising an electrode and at least one detection component coupled to the electrode, the method comprising:
measuring an optical or electrical property of the electrode assembly at one or more points during operation of the melting furnace; and
correlating the measured optical or electrical property to a length of the electrode.

28. The method of claim 27, wherein an abrupt change in the measured optical or electrical property is correlated to a minimum length of the electrode.

29. The method of claim 27, wherein a gradual change in the measured optical or electrical property is correlated to a gradual change in the length of the electrode.

30. The method of claim 27, wherein the at least one detection component is an electrical probe comprising a conductive core and at least one insulating layer surrounding the conductive core, and wherein the measured electrical property is a resistance or capacitance of the conductive core.

31. The method of claim 27, wherein the at least one detection component is an insulating layer disposed between two portions of the electrode, and wherein the measured electrical property is a capacitance between the two portions of the electrode.

32. The method of claim 27, wherein the at least one detection component is an insulating rod comprising two conductive wires connected to an electrical oscillator circuit, and wherein the measured electrical property is an oscillation period or frequency of the electrical oscillator circuit.

33. The method of claim 27, wherein the at least one detection component is an optical probe, and wherein the measured optical property is a light intensity, backscattered light intensity, or optical reflectivity of the optical probe.
